(19) United States
(12) Patent Application Publication
(10) Pub. No.: US 2026/0222159 A1
(43) Pub. Date: Jul. 30, 2026

(54) COMB OFFSET RANDOMIZATION

(71) Applicant: Nokia Technologies Oy, Espoo (FI)

(72) Inventors: Antti ARVOLA, Oulu (FI); Bikshapathi GOUDA, Oulu (FI); Italo ATZENI, Oulu (FI); Antti TÖLLI, Oulu (FI); Juha Pekka KARJALAINEN, Oulu (FI); Sami-Jukka HAKOLA, Oulu (FI); Timo KOSKELA, Oulu (FI); Youngsoo YUK, Seoul (KR)

(21) Appl. No.: 19/151,718

(22) PCT Filed: Feb. 17, 2023
(86) PCT No.: PCT/EP2023/054040

§ 371 Date: Jul. 29, 2025

(51) Int. Cl. H04L 5/00; H04W 72/0453; H04W 72/23

(52) U.S. Cl. CPC H04L 5/0073; H04L 5/0012; H04L 5/0051; H04L 5/0094; H04W 72/0453; H04W 72/23

(57) ABSTRACT

To minimize collisions for sounding reference signals transmitted using a frequency hopping different comb offset randomization schemes are disclosed. An apparatus may receive sounding reference signal configuration information on at least one comb offset randomization scheme, which indicates at least division of a sounding reference signal bandwidth to a plurality of sub-bands and associated comb offsets. The apparatus may apply a comb offset randomization scheme for sounding reference signal transmissions when an indication that indicates to apply the comb offset randomization scheme is received.

### TECHNICAL FIELD

Various example embodiments relate to communication systems.

### BACKGROUND

Communication systems are under constant development. The 5G, 5G-Advanced, and beyond future wireless networks, or network generations, aim to support a large variety of services, use cases and industrial verticals. One of the defining features in 5G (fifth generation) has been utilization of multiple-input multiple-output (MIMO) technology also in apparatuses, for example user equipments, to which wireless resources are allocated. For resource allocation, such an apparatus will be configured to transmit sounding reference signals per an output port of the apparatus to the wireless network, so that the wireless network can estimate channel quality. To enhance uplink capacity for sounding reference signals a frequency hopping with comb offset may be applied on the bandwidth allocated for sounding reference signals. However, it may be that sounding reference signal transmissions from two different sources collide, resulting to performance degradation. Hence, there is a need for a solution to minimize a probability of sounding reference signal collisions.

### SUMMARY

The independent claims define the scope, and different embodiments are defined in dependent claims.

According to an aspect there is provided an apparatus comprising at least one processor and at least one memory storing instructions that, when executed by the at least one processor, cause the apparatus at least to: receive sounding reference signal configuration information on at least one comb offset randomization scheme, which indicates at least division of a sounding reference signal bandwidth to a plurality of sub-bands and associated comb offset values; receive an indication, whether to apply a comb offset randomization scheme; and apply one of the at least one comb offset randomization scheme for sounding reference signal transmissions when the indication indicates to apply the comb offset randomization scheme.

In embodiments, the at least one processor and the at least one memory storing instructions, when executed by the at least one processor, further cause the apparatus at least to: receive at least a first comb offset randomization scheme comprising comb offset candidate patterns for multiple pattern sizes, a candidate pattern having a pattern identifier and being associated with a pattern size; receive an indication of a pattern size to be used with the sounding reference signal transmissions; and select, based on the pattern size indicated, from the candidate comb offset patterns, a comb offset pattern to be applied for the sounding reference signal transmissions.

In embodiments, the at least one processor and the at least one memory storing instructions, when executed by the at least one processor, further cause the apparatus at least to: receive a selection of a subset of the comb offset candidate patterns; and select the comb offset pattern from the subset of the comb offset candidate patterns.

In embodiments, the at least one processor and the at least one memory storing instructions, when executed by the at least one processor, further cause the apparatus at least to: receive a second comb offset randomization scheme comprising a plurality of comb offset patterns, a comb offset pattern per a set of resource blocks associated with the sounding reference signal bandwidth; and apply, when no indication of the pattern size is received, the second comb offset randomization scheme for the sounding reference signal transmissions.

In embodiments, the at least one processor and the at least one memory storing instructions, when executed by the at least one processor, further cause the apparatus at least to: receive a third comb offset randomization scheme indicating the division of the sounding reference signal bandwidth and use of the pseudorandom comb offset values; and generate, when no indication of the pattern size and no second comb offset randomization scheme are received, pseudorandom comb offset values using at least an index of the apparatus, an index associated with a sub-band and a time instance; and apply pseudorandom comb offset values generated for the sounding reference signal transmissions.

In embodiments, the at least one processor and the at least one memory storing instructions, when executed by the at least one processor, further cause the apparatus at least to: receive a third comb offset randomization scheme indicating the division of the sounding reference signal bandwidth and use of the pseudorandom comb offset values; and generate, when no indication of the pattern size and no second comb offset randomization scheme are received, pseudorandom comb offset values using at least an index of the apparatus, an index associated with a sub-band and a time instance; and apply pseudorandom comb offset values generated for the sounding reference signal transmissions.

In embodiments, the at least one processor and the at least one memory storing instructions, when executed by the at least one processor, further cause the apparatus at least to: generate pseudorandom comb offset values using at least an index of the apparatus, an index associated with a sub-band and a time instance; apply pseudorandom comb offset values generated for the sounding reference signal transmissions.

In embodiments, the at least one processor and the at least one memory storing instructions, when executed by the at least one processor, further cause the apparatus at least to: receive at least one specific comb offset value; and generate pseudorandom comb offset values using also the at least one specific comb offset value to generate pseudorandom comb offset values.

In embodiments, the at least one comb offset randomization scheme comprises a plurality of comb offset patterns, a comb offset pattern per a set of resource blocks associated with the sounding reference signal bandwidth.

According to an aspect there is provided an apparatus comprising at least one processor and at least one memory storing instructions that, when executed by the at least one processor, cause the apparatus at least to: transmit sounding reference signal configuration information on at least one comb offset randomization scheme, which indicates at least division of a sounding reference signal bandwidth to a plurality of sub-bands and associated comb offset values; transmit to at least one second apparatus an indication to apply a comb offset randomization scheme; and process, using the comb offset randomization scheme, sounding reference signal transmission received from the at least one second apparatus.

In embodiments, the at least one processor and the at least one memory storing instructions, when executed by the at least one processor, further cause the apparatus at least to: transmit to the at least one second apparatus a first comb offset randomization scheme comprising comb offset candidate patterns for multiple pattern sizes, a candidate pattern having a pattern identifier and being associated with a pattern size; and transmit to the at least one second apparatus an indication of a pattern size.

In embodiments, the at least one processor and the at least one memory storing instructions, when executed by the at least one processor, further cause the apparatus at least to: select one or more subsets from the comb offset candidate patterns for multiple pattern sizes; and transmit at least to one of the at least one second apparatus in the first comb offset randomization scheme a subset of the comb offset candidate patterns.

In embodiments, the at least one processor and the at least one memory storing instructions, when executed by the at least one processor, further cause the apparatus at least to transmit a second comb offset randomization scheme comprising a plurality of comb offset patterns, a comb offset pattern per a set of resource blocks associated with the sounding reference signal bandwidth.

In embodiments, the at least one processor and the at least one memory storing instructions, when executed by the at least one processor, further cause the apparatus at least to: transmit a third comb offset randomization scheme indicating the division of the sounding reference signal bandwidth and use of the pseudorandom comb offset values; and generate, per a received sounding reference signal from a second apparatus, a pseudorandom comb offset value using at least an index of the second apparatus, an index associated with the sub-band and a time instance of the sounding reference signal.

In embodiments, the at least one processor and the at least one memory storing instructions, when executed by the at least one processor, further cause the apparatus at least to: transmit to a second apparatus in the third comb offset randomization scheme a at least one specific comb offset value that is assigned to the second apparatus; and use the at least one specific comb offset value when processing sounding reference signals from the second apparatus.

According to an aspect there is provided a method comprising: receiving sounding reference signal configuration information on at least one comb offset randomization scheme, which indicates at least division of a sounding reference signal bandwidth to a plurality of sub-bands and associated comb offset values; receiving an indication, whether to apply a comb offset randomization scheme; and applying one of the at least one comb offset randomization scheme for sounding reference signal transmissions when the indication indicates to apply the comb offset randomization scheme.

In embodiments, the method further comprises: receiving a first comb offset randomization scheme comprising comb offset candidate patterns for multiple pattern sizes, a candidate pattern having a pattern identifier and being associated with a pattern size; receiving an indication of a pattern size to be used with the sounding reference signal transmissions; and selecting, based on the pattern size indicated, from the candidate comb offset patterns, a comb offset pattern to be applied for the sounding reference signal transmissions.

In embodiments, the method further comprises: receiving a selection of a subset of the comb offset candidate patterns; and selecting the comb offset pattern from the subset of the comb offset candidate patterns.

In embodiments, the method further comprises: receiving a second comb offset randomization scheme comprising a plurality of comb offset patterns, a comb offset pattern per a set of resource blocks associated with the sounding reference signal bandwidth; and applying, when no indication of the pattern size is received, the second comb offset randomization scheme for the sounding reference signal transmissions.

In embodiments, the method further comprises: receiving a third comb offset randomization scheme indicating the division of the sounding reference signal bandwidth and use of the pseudorandom comb offset values; generating, when no indication of the pattern size and no second comb offset randomization scheme are received, pseudorandom comb offset values using at least an index of the apparatus, an index associated with a sub-band and a time instance; and applying the pseudorandom comb offset values generated for the sounding reference signal transmissions.

In embodiments, the method further comprises: receiving a third comb offset randomization scheme indicating the division of the sounding reference signal bandwidth and use of the pseudorandom comb offset values; generating, when no indication of the pattern size and no second comb offset randomization scheme are received, pseudorandom comb offset values using at least an index of the apparatus, an index associated with a sub-band and a time instance; and applying the pseudorandom comb offset values generated for the sounding reference signal transmissions.

In embodiments, the method further comprises: generating pseudorandom comb offset values using at least an index of the apparatus, an index associated with a sub-band and a time instance; and applying pseudorandom comb offset values for the sounding reference signal transmissions.

In embodiments, the method further comprises: receiving at least one specific comb offset value; and generating pseudorandom comb offset values using also the at least one specific comb offset value.

In embodiments, the at least one comb offset randomization scheme comprises a plurality of comb offset patterns, a comb offset pattern per a set of resource blocks associated with the sounding reference signal bandwidth.

According to an aspect there is provided a method comprising: transmitting sounding reference signal configuration information on at least one comb offset randomization scheme, which indicates at least division of a sounding reference signal bandwidth to a plurality of sub-bands and associated comb offset values; transmitting to at least one second apparatus an indication to apply a comb offset randomization scheme; and processing, using the comb offset randomization scheme, sounding reference signal transmission received from the at least one second apparatus.

In embodiments, the method further comprises: transmitting a first comb offset randomization scheme comprising comb offset candidate patterns for multiple pattern sizes, a candidate pattern having a pattern identifier and being associated with a pattern size; and transmitting an indication of a pattern size.

In embodiments, the method further comprises: selecting one or more subsets from the comb offset candidate patterns for multiple pattern sizes; transmitting to at least one second apparatus in the first comb offset randomization scheme a subset of the comb offset candidate patterns.

In embodiments, the method further comprises: transmitting a second comb offset randomization scheme comprising a plurality of comb offset patterns, a comb offset pattern per a set of resource blocks associated with the sounding reference signal bandwidth.

In embodiments, the method further comprises: transmitting a third comb offset randomization scheme indicating the division of the sounding reference signal bandwidth and use of the pseudorandom comb offset values; and generating, per a received sounding reference signal from a second apparatus, a pseudorandom comb offset value using at least an index of the second apparatus, an index associated with the sub-band and a time instance of the sounding reference signal.

In embodiments, the method further comprises: transmitting to one of the at least one second apparatus in the third comb offset randomization scheme at least one specific comb offset value that is assigned to the second apparatus; and using the at least one specific comb offset value when processing sounding reference signals from the one of the at least one second apparatus.

According to an aspect there is provided a computer readable medium comprising instructions which, when executed by an apparatus, cause the apparatus to perform at least the following: receiving sounding reference signal configuration information on at least one comb offset randomization scheme, which indicates at least division of a sounding reference signal bandwidth to a plurality of sub-bands and associated comb offset values; receiving an indication, whether to apply a comb offset randomization scheme; and applying one of the at least one comb offset randomization scheme for sounding reference signal transmissions when the indication indicates to apply the comb offset randomization scheme.

According to an aspect there is provided a computer readable medium comprising instructions which, when executed by an apparatus, cause the apparatus to perform at least the following: transmitting sounding reference signal configuration information on at least one comb offset randomization scheme, which indicates at least division of a sounding reference signal bandwidth to a plurality of sub-bands and associated comb offset values; transmitting to at least one second apparatus an indication to apply a comb offset randomization scheme; and processing, using the comb offset randomization scheme, sounding reference signal transmission received from the at least one second apparatus.

According to an aspect there is provided a non-transitory computer readable medium comprising instructions which, when executed by an apparatus, cause the apparatus to perform at least the following: receiving sounding reference signal configuration information on at least one comb offset randomization scheme, which indicates at least division of a sounding reference signal bandwidth to a plurality of sub-bands and associated comb offset values; receiving an indication, whether to apply a comb offset randomization scheme; and applying one of the at least one comb offset randomization scheme for sounding reference signal transmissions when the indication indicates to apply the comb offset randomization scheme.

According to an aspect there is provided a non-transitory computer readable medium comprising instructions which, when executed by an apparatus, cause the apparatus to perform at least the following: transmitting sounding reference signal configuration information on at least one comb offset randomization scheme, which indicates at least division of a sounding reference signal bandwidth to a plurality of sub-bands and associated comb offset values; transmitting to at least one second apparatus an indication to apply a comb offset randomization scheme; and processing, using the comb offset randomization scheme, sounding reference signal transmission received from the at least one second apparatus.

According to an aspect there is provided a computer program comprising instructions, which, when executed by an apparatus, cause the apparatus to perform any of the methods disclosed above.

According to an aspect there is provided an apparatus comprising: means for receiving sounding reference signal configuration information on at least one comb offset randomization scheme, which indicates at least division of a sounding reference signal bandwidth to a plurality of sub-bands and associated comb offset values; means for receiving an indication, whether to apply a comb offset randomization scheme; and means for applying one of the at least one comb offset randomization scheme for sounding reference signal transmissions when the indication indicates to apply the comb offset randomization scheme.

In embodiments, the apparatus further comprises means for performing any of the methods disclosed above.

According to an aspect there is provided an apparatus comprising: means for transmitting sounding reference signal configuration information on at least one comb offset randomization scheme, which indicates at least division of a sounding reference signal bandwidth to a plurality of sub-bands and associated comb offset values; means for transmitting to at least one second apparatus an indication to apply a comb offset randomization scheme; and means for processing, using the comb offset randomization scheme, sounding reference signal transmission received from the at least one second apparatus.

In embodiments, the apparatus further comprises means for performing any of the methods disclosed above.

### BRIEF DESCRIPTION OF DRAWINGS

Embodiments are described below, by way of example only, with reference to the accompanying drawings, in which

FIG. 1 illustrates an exemplified high-level network architecture;

FIG. 2 illustrates an example functionality;

FIG. 3 illustrates an example functionality;

FIG. 4 illustrates an example information exchange and functionality;

FIG. 5 illustrates an example information exchange and functionality;

FIG. 6 illustrates an example information exchange and functionality;

FIG. 7 illustrates examples of comb offsets;

FIG. 8 illustrates examples of patterns;

FIG. 9 illustrates an example functionality;

FIG. 10 illustrates an example of a pattern;

FIG. 11 illustrates an example of a pattern; and

FIG. 12 to FIG. 14 are schematic block diagrams.

### DETAILED DESCRIPTION OF SOME EMBODIMENTS

The following embodiments are only presented as examples. Although the specification may refer to “an”, “one”, or “some” embodiment(s) and/or example(s) in several locations, this does not necessarily mean that each such reference is to the same embodiment(s) or example(s), or that a particular feature only applies to a single embodiment and/or single example. Single features of different embodiments and/or examples may also be combined to provide other embodiments and/or examples. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the elements are not restricted by the terms. The terms are used merely for the purpose of distinguishing an element from other elements. For example, a first element could be termed an element or a second element, and similarly, a second element could be also termed a first element or an element without departing from the scope of the present disclosure.

5G-Advanced, and beyond future wireless networks aim to support a large variety of services, use cases and industrial verticals, for example unmanned mobility with fully autonomous connected vehicles, other vehicle-to-everything (V2X) services, or smart environment, e.g. smart industry, smart power grid, or smart city, just to name few examples. To provide variety of services with different requirements, such as enhanced mobile broadband, ultra-reliable low latency communication, massive machine type communication, wireless networks are envisaged to adopt network slicing, flexible decentralized and/or distributed computing systems and ubiquitous computing, with local spectrum licensing, spectrum sharing, infrastructure sharing, and intelligent automated management underpinned by mobile edge computing, artificial intelligence, for example machine learning, based tools, cloudification and blockchain technologies. For example, in the network slicing multiple independent and dedicated network slice instances may be created within the same infrastructure to run services that have different requirements on latency, reliability, throughput and mobility.

6G (sixth generation) networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G will include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

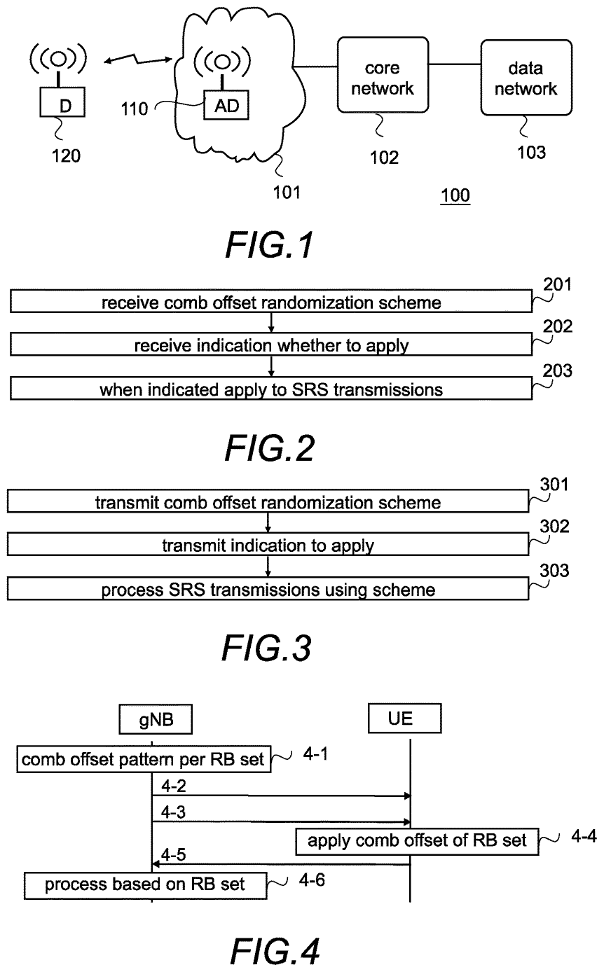

FIG. 1 illustrates an exemplified high-level network architecture of a communication system 100, only showing some details, the more detailed implementation being irrelevant for the description of examples. The examples are described herein using principles and terminology of 5G-Advanced, without limiting the examples, and the terminology used, to said 5G-Advanced. A person skilled in the art may apply the solutions and examples to other communication systems, for example beyond 5G-Advanced, or communication system implementing similar principles and functionalities, possibly with different terms having corresponding meaning, but using some other than 5G technology. For example, a sounding reference signal (SRS) represents herein any uplink reference signal. The uplink reference signal, e.g. SRS, may be transmitted for different purposes. A non-limiting list of purposes include sounding an uplink channel state information (CSI) for uplink precoder selection (covering both codebook and non-codebook based precoding options), uplink channel estimation, scheduling purposes, downlink CSI acquisition purposes via antenna switching, or uplink beam management purposes.

Referring to FIG. 1, a radio access network 101 provides wireless access via a core network 102 to one or more data networks 103.

The radio access network may be a 5G-Advanced network, an open radio access network, a cloud radio access network, a non-terrestrial network, or a non-cellular access network, for example a wireless local area network, implementing the multiple-input-multiple output and a frequency hopping with comb offset(s) for sounding reference signals.

To provide the wireless access, the radio access network 101 comprises access devices (AD) 110 which may provide one or more cells. There are a wide variety of access devices, including different types of base stations, such as eNBs, gNBs, split gNBs, transmission-reception points, network-controlled repeaters, donor nodes in integrated access and backhaul (IAB), fixed IAB nodes, mobile IAB nodes mounted on vehicles, for example, and satellites. As said above, an access device may provide one or more cells, possibly with different cell accessibility per cell, but a cell is provided by one access device. However, there may be overlapping cells, for example a macro cell provided by an access device operating in co-operation of access nodes providing smaller cells, such as micro-, femto- or picocells, which overlap at least partly within the macro cell. In some scenarios, the access node 110, for example gNB, may configure, per a serving cell, the serving cell via one transmission-reception point (TRP), or via two or more of the transmission-reception points, the latter being called a multi-TRP scenario. A wireless connection to a device (D) 120 may be provided via an antenna unit that may comprise a plurality of antennas or antenna elements, with antenna ports, for the multiple-input, multiple-output (MIMO) technology.

The core network 102 may be based on a non-standalone core network, for example an long term evolution, LTE-based network, or a standalone access network, for example a 5G core network. However, it should be appreciated that the core network 102 may use any technology that enable network services, for example, to be delivered between devices and data networks.

The data network 103 may be any network, like the internet, an intranet, a wide area network, etc. Different remote monitoring and/or data collection services for different use cases may be reached via the data network 103.

The device 120 may be any electrical device connectable to an access network 101 and configurable to be in a wireless connection on one or more communication channels with the access device 110 providing the cell. The physical link from the device 120 to the radio access network 101 towards the core network 102 is called uplink or reverse link and the physical link to the device is called downlink or forward link. By way of example rather than limitation, the device 120 may referred to as a terminal device, a communication device, a user equipment (UE), a subscriber station (SS), a portable subscriber station, a mobile station (MS), or an access terminal (AT). A non-limiting lists of examples of the device 120, or what the device 120 may comprise or be comprised in, include a mobile phone, a cellular phone, a smart phone, a voice over internet protocol (VOIP) phone, a wireless local loop phone, a tablet, a device using a wireless modem, a personal digital assistant (PDA), a portable computer, a desktop computer, laptop-embedded equipment (LEE), laptop-mounted equipment (LME), a universal serial bus (USB) dongle, a smart device, a multimedia device, an image capture terminal device, such as a digital camera, a gaming terminal device, a music storage and playback appliance, a drone, a vehicle, a vehicle-mounted wireless terminal device, a wireless endpoint, wireless customer-premises equipment (CPE), an internet of things device, an industrial internet of things device, a device operating in an industrial and/or an automated processing chain contexts, a consumer electronics device, a consumer internet of things device, a mobile robot, a mobile robot arm, a sensor, such as a pressure sensor, humidity sensor, thermometers, motion sensors, actuators, accelerometers, etc., a surveillance camera, an eHealth related device, a medical device, for example for remote surgery, a wearable device, such as a smart watch, a smart ring, a head-mounted display (HMD), an on-person device. The device 120 may also provide services to other devices, for example be a relay node, a fixed IAB node, or a mobile IAB node, or a mobile termination part in an IAB node. The device may also be part of a group of devices seen as one device by the wireless network. A number of reception and/or transmission antennas or antenna elements, with antenna ports, in a device may vary according to implementation and/or type of the device.

In 5G-Advanced coherent joint transmission (CJT), which combines multiple MIMO antenna arrays into a much larger one, is an efficient way to improve the system spectral efficiency and user experience, particularly for cell-edge devices 120. In general, uplink sounding reference signal (UL SRS) transmissions may experience interference, i.e. cross-SRS interference, which may become a serious issue impacting channel state information (CSI) quality that may limit potential merits, e.g. interference reduction in downlink, and performance, e.g. throughput or spectral efficiency of time division duplexing (TDD) based coherent joint transmission for physical downlink data shared channel (PDSCH) transmission in multi-TRP scenarios. To reduce the impact of the UL SRS interference to a system performance, comb offset randomization schemes for sounding reference signals may be used. Examples of such comb offset randomization schemes are disclosed below. A comb offset means herein an offset in resource elements in frequency domain from the start of the comb-pattern, the comb offset value being in the start zero (0). A comb offset pattern provides pseudo-randomized comb offset value(s) for a plurality of sets of resource blocks, such as physical resource blocks in frequency domain, wherein a comb offset pattern comprises one or more comb offset values. A comb offset pattern may be two/or one dimensional covering frequency domain and/or time domain. A frequency domain comb offset pattern is applicable with aperiodic resources, with semi-persistent resources and with periodic resources. A time domain comb offset pattern is applicable with semi-persistent resources and with periodic resources. Herein a sounding reference signal bandwidth means resources allocated for SRS transmissions, and a sub-band refers to a set of resource blocks, such as physical resource blocks in frequency domain, the set comprising one or more resource blocks. Further, configuration information on a comb offset randomization scheme covers herein also configuration information on a resource configuration for the comb offset randomization scheme.

The non-limiting examples are illustrated by means of FIG. 2 to FIG. 9, assuming that the apparatuses are configured to support at least the illustrated comb offset randomization scheme(s). For example, it is assumed that the apparatus transmitting sounding reference signals has indicated the wireless network, for example via capability signalling, that it supports at least the comb offset randomization scheme illustrated with a corresponding figure.

It should be appreciated that the principles disclosed below with different examples may be applied in addition to a single apparatus to a group of apparatuses. For example, a group identifier or index may be used instead of an identifier or an index of a single apparatus.

FIG. 2 illustrates an example functionality of an apparatus that will send sounding reference signals to the wireless network.

Referring to FIG. 2, sounding reference signal configuration information on at least one comb offset randomization scheme is received in block 201. The comb offset randomization scheme indicates at least division of a sounding reference signal bandwidth to a plurality of sub-bands, and associated comb offset values. There may be a comb offset value per a sub-band, for example a comb offset A for sub-band 1, and a comb offset B for sub-band 2. Different alternatives for comb offset randomization schemes will be described in more detail with FIG. 4 to FIG. 6, for example.

When an indication, whether to apply to apply a comb offset randomization scheme is received in block 202, and the indication indicates to apply the comb offset randomization scheme, the comb offset randomization scheme for sounding reference signal transmissions is applied in block 203. Different alternatives what are described in more detail below with FIG. 4 to FIG. 6.

The indication, whether to apply a comb offset randomization scheme may be a 1-bit flag, whose value indicates whether or not to apply the comb offset randomization scheme for SRS transmission(s). The indication may be an 1-bit indicator (value ON or OFF indicates), an information element, or any other parameter, e.g. a comb offset hopping specific parameter, or an implicit indication. The implicit indication may be based on TDD based CJT specific parameter, or receiving one or more comb offset randomization scheme(s) may be the indication. Further the indication may indicate which comb offset randomization scheme to use.

The comb offset randomization scheme may be received in radio resource control signaling, and depending on an implementation, the indication may be received in a higher layer signaling, e.g. the radio resource control (RRC) signaling, and/or in a medium access control (MAC) control element (CE), and/or in downlink control information (DCI).

FIG. 3 illustrates an example functionality of an apparatus in a wireless network that will receive sounding reference signals from second apparatuses and configure transmission of the sounding reference signals.

Referring to FIG. 3, sounding reference signal configuration information on at least one comb offset randomization scheme is transmitted in block 301. The comb offset randomization scheme indicates at least division of a sounding reference signal bandwidth to a plurality of sub-bands and associated comb offsets. There may be a comb offset value per a sub-band, for example a comb offset A for sub-band 1, and a comb offset B for sub-band 2. Different alternatives for comb offset randomization schemes will be described in more detail with FIG. 4 to FIG. 6, for example.

Further, an indication to apply a comb offset randomization scheme is transmitted in block 302 to at least one second apparatus, e.g. the device D depicted by block 120 in FIG. 1. The indication, whether to apply a comb offset randomization scheme may be a 1-bit flag, whose value indicates whether or not to apply the comb offset randomization scheme. The indication may be an 1-bit indicator (value ON or OFF indicates), an information element, or any other parameter, e.g. a comb offset hopping specific parameter, or an implicit indication. The implicit indication may be based on TDD based CJT specific parameter, or receiving one or more comb offset randomization scheme(s) may be the indication. Further the indication may indicate which one of comb offset randomization schemes to use.

The comb offset randomization scheme may be transmitted in radio resource control signaling, and depending on an implementation, the indication (the indication of the usage of the scheme) may be transmitted in the radio resource control (RRC) signaling, and/or in a medium access control (MAC) control element (CE), and/or in downlink control information (DCI).

When a sounding reference signal transmission is received from a second apparatus, the sounding reference signal transmission is processed in block 303 using the comb offset randomization scheme specific processing, for example as will be described in more detail with FIG. 4 to FIG. 6.

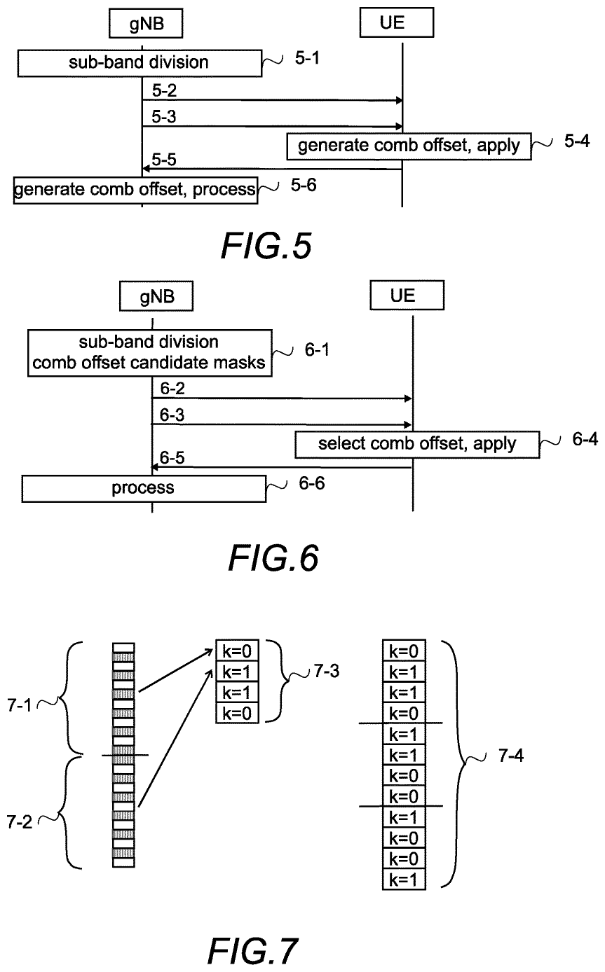

FIG. 4, FIG. 5 and FIG. 6 illustrate exemplified information exchanges between different apparatuses in a radio network configured to support at least one comb offset randomization scheme. Different examples of comb offset randomization schemes are illustrated in separate figures for the sake of clarity. The comb offset randomization schemes may be implemented separately, or the network and/or the apparatus transmitting sounding reference signals may be configured to support two of them or all of them, wherein the apparatus may receive all configurations, two of them or one of them, and apply the one indicated by the network, for example as will be described with FIG. 9. For the sake of clarity of the description, only two apparatuses that may communicate over an air interface are illustrated, one of the apparatuses, denoted “gNB”, at least receiving uplink transmissions and transmitting downlink, the other apparatus, denoted “UE”, at least receiving downlink transmissions and transmitting uplink, without limiting the example to such a solution and apparatuses. The apparatus “gNB” may be, for example, a transmission-reception-point or a distributed unit, or any corresponding unit, examples of which are listed above with reference to block 110 in FIG. 1, and it illustrates network functionality. The apparatus “UE” may be, for example, a user equipment, or any corresponding unit, examples of which are listed above with reference to block 120 in FIG. 1. Further, even though the examples illustrate one sounding reference signal transmission, it should be appreciated that it depicts a plurality of sounding reference signal transmission occasions. For example, the sounding reference signal configuration may indicate that it will be used as long as a new configuration is received, or for certain time period.

In the example of FIG. 4, a comb offset randomization scheme comprises a plurality of comb offset patterns, a comb offset pattern per a resource block associated with the sounding reference signal bandwidth. In other words, the comb offset patterns are at a level of a set of physical resource blocks for all configured sets of physical resource blocks associated with uplink sounding reference signal bandwidth.

Referring to FIG. 4, the apparatus gNB performs the sub-band division by the granularity of a set of resource blocks (i.e. set of resource blocks may be associated with one sub-band) and associates a comb offset pattern per a set of resource blocks in block 4-1. Then the apparatus gNB configures the apparatus UE by transmitting (one or more messages 4-2) sounding reference signal configuration information, which contains comb offset patterns for the resource blocks. Message(s) 4-2 may be RRC signaling.

The apparatus UE receives the sounding reference signal configuration information, and configures itself correspondingly.

The apparatus gNB transmits (message 4-3) to the apparatus UE an indication, which in the illustrated example indicates to the apparatus UE that the comb offset patterns are to be applied. Depending on an implementation, message 4-3 may be a separate message, or part of message 4-2.

When the apparatus UE receives the indication, it will apply in block 4-4 the comb offset patterns when transmitting (one or more messages 4-5) sounding reference signals. In other words, the apparatus UE determines, per a set of resource blocks the apparatus UE is allocated to use for transmission, the comb offset pattern associated with the set of resource blocks and will use the comb offset pattern. More precisely, the apparatus UE will apply in block 4-4 a comb offset pattern on top of a comb offset value associated with a configured SRS resource, for example by summing up a comb offset value indicated in the pattern with the comb offset value of the configured SRS resource into a configured comb offset value.

When the apparatus gNB receives the sounding reference signals, the apparatus gNB will process in block 4-6 the sounding reference signals using, per a set of resource blocks, comb offset pattern associated with the set of resource blocks.

The example illustrated in FIG. 4 has a level of coordination that minimizes the amount of cross-SRS interference and has the least ambiguity compared to solutions described in FIG. 5 and FIG. 6 at a cost of more overhead.

In the example of FIG. 5, a comb offset randomization scheme is based on pseudorandom offsets generated using at least an index of the apparatus UE, an index associated with a sub-band and a time instance. A sub-band may comprise one or more resource blocks. An index of the apparatus UE may be an identifier, e.g. a temporary identifier, used by the network to identify the apparatus UE. For example, the index of the apparatus UE may be based on a radio network temporary identifier. In the illustrated example it is assumed that the apparatus gNB and the apparatus UE are using similar pseudorandom generators to ensure that a pseudorandom pattern used by the apparatus UE can be reconstructed by the apparatus gNB. It may that information on pseudorandom generator used by the apparatus UE may be transmitted to the network, e.g. to the apparatus gNB in the capability information.

Referring to FIG. 5, the apparatus gNB performs the sub-band division and associates sub-bands with indices, an index per a sub-band, in block 5-1. The associating may be an explicit association or an implicit associating, e.g. an index may be determined based on the location of the sub-band in the whole band. An implicit association may also be based on other TDD based CJT specific parameters or DCI triggering SRS transmission. For example, if SRS transmission is triggered with a group common DCI, e.g. DCI 0_2, some default randomization pattern may be applied, if not specifically indicated in said DCI.

Then the apparatus gNB configures the apparatus UE by transmitting (one or more messages 5-2) sounding reference signal configuration information, which indicates the division of the sounding reference signal bandwidth and use of the pseudorandom comb offset values. Message(s) 5-2 may be RRC signaling. In an implementation, the apparatus gNB, may be configured to assign to the apparatus UE at least one specific comb offset value and transmit the specific comb offset value (UE-specific comb offset value) in the sounding reference signal configuration information, for example in downlink control information. The specific comb offset value allows a degree of control for the network, possibly to avoid certain initializations for the pseudorandom generator in the apparatus UE that may result in high SRS collisions with the legacy SRS transmission. The specific comb offset value may be common to the multiple sub-bands, or be a sub-band specific comb offset value. When sub-band specific comb offset values are used, message 5-2 comprises a plurality of specific comb offset values.

The apparatus UE receives the sounding reference signal configuration information, and configures itself correspondingly. Message(s) 5-2 initialize a pseudorandom generator in the apparatus UE.

The apparatus gNB transmits (message 5-3) to the apparatus UE an indication, which in the illustrated example indicates to apply the pseudorandom comb offset values. Depending on an implementation, message 5-3 may be a separate message, or part of the one or more messages 5-2.

When the apparatus UE receives the indication, it will apply in block 5-4 the pseudorandom comb offset patterns when transmitting (one or more messages 5-5) sounding reference signals. In other words, the apparatus UE generates pseudorandom comb offset values using at least an index of the apparatus, an index associated with a sub-band and a time instance of the transmission occurrence, and will use the thus obtained comb offset values. More precisely, the apparatus UE will apply in block 5-4 a comb offset value generated for a sub-band on top of a comb offset value associated with a configured SRS resource, for example by summing up a comb offset value indicated in the pattern with the comb offset value of the configured SRS resource into a configured comb offset value. When the at least one specific comb offset values is received, the apparatus UE generates pseudorandom comb offset values using at least the index of the apparatus, the index associated with a sub-band, the time instance of the transmission occurrence and the specific comb offset value.

When the apparatus gNB receives the sounding reference signals, the apparatus gNB will generate, per a received sounding reference signal from the apparatus UE, a pseudorandom comb offset value using at least the index of the second apparatus, the index associated with the sub-band and the time instance of the sounding reference signals, and then process in block 5-6 the sounding reference signals using the pseudorandom comb offset value generated. When the apparatus UE has been assigned the at least one specific comb offset value, the apparatus gNB uses the at least one specific comb offset value when generating the pseudorandom offset.

By the index of the apparatus UE, apparatuses transmitting sounding reference signals are provided separate pseudorandom generator seeds. The index associated with the sub-band, for example a physical resource block index, ensures independently generated comb offset value per a sub-band. Further, the time instant ensures that a sounding reference signal occasion has an independent comb offset value.

In the example of FIG. 6, comb offset candidate patterns for multiple sub-band sizes are used.

Referring to FIG. 6, the apparatus gNB performs in block 6-1 the sub-band division by the granularity of one or more resource blocks, and obtains or generates comb offset candidate pattern for multiple pattern sizes corresponding to the sub-band sizes, wherein a candidate pattern have a corresponding pattern identifier. For example, candidate patterns may be generated for M sizes, e.g. M=2, 4, 8, 12, etc. Further, the M may be different for different apparatuses UE. In an implementation, the apparatus gNB may select in block 6-1 one or more subsets from the comb offset candidate patterns for multiple pattern sizes for the apparatus UE. Then the apparatus gNB configures the apparatus UE by transmitting (one or more messages 6-2) sounding reference signal configuration information, which contains comb offset candidate patterns for multiple pattern sizes, a candidate pattern having a pattern identifier and being associated with a pattern size, and an indication of a pattern size to be used. Message(s) 6-2 may be RRC signaling. In an implementation, the indication of the pattern size to be used may be transmitted with medium access level signaling, and/or indicated using downlink control information, for example in a later signaling that the signaling comprising candidate patterns. Further, the subset may be selected by activating a subset of comb offset candidate patterns with medium access level signaling, and/or indicated using downlink control information. The number of bits used for indicating may depend on the number of pattern sizes. For example, if sizes M=4 and M=8 are configured, one bit may convey the information, for example “bit=0 to use M=4”, “bit=1 to use M=8”, “bit=‘void’ to not use comb offset randomization”.

The apparatus UE receives the sounding reference signal configuration information, and configures itself correspondingly.

The apparatus gNB transmits (message 6-3) to the apparatus an indication, which in the illustrated example indicates to apply the comb offset patterns. Depending on an implementation, message 6-3 may be a separate message, or part of message 6-2. Further, the indication may also contain information on a pattern size to be used.

When the apparatus UE receives the indication, it will select in block 6-4, based on the pattern size indicated, from the candidate comb offset patterns, or from the sub-set of the candidate comb offset pattern, a comb offset pattern (a comb offset pattern) for the sounding reference signal transmissions. The apparatus UE may be configured with a selection criteria, known also by the apparatus gNB. For example, the selection may be based on symbol index and/or the index of the apparatus UE and/or a cell identifier. The apparatus UE applies in block 6-4 the selected comb offset pattern (comb offset pattern) when transmitting (one or more messages 6-5) sounding reference signals. The apparatus UE may perform the selecting per a reference signal transmission occurrence. Further, the apparatus UE will apply in block 6-4 the selected comb offset pattern when transmitting (one or more messages 6-5) sounding reference signals. More precisely, the apparatus UE will apply in block 6-4 a comb offset pattern on top of a comb offset value associated with a configured SRS resource, for example by summing up a comb offset value indicated in the selected comb offset pattern with the comb offset value of the configured SRS resource into a configured comb offset value. The selected comb offset pattern may be repeated over the entire SRS bandwidth with possible cyclic shifts of the pattern between sub-bands. In an implementation, if the SRS bandwidth is not a multiple of the pattern size, for the remaining resource blocks a predefined subset of the selected pattern may be used. For example, if the pattern size is M, a subset of first N (when N<M) resource blocks may be used.

When the apparatus gNB receives the sounding reference signals, the apparatus gNB will process in block 6-6 the sounding reference signals by selecting, using the selection criteria used by the apparatus UE, the pattern and using the selected pattern.

FIG. 7 illustrates an example of a pattern configuration for a comb-2 structure (every 2^{nd} resource in a physical resource block is configured for SRS resource) and a pattern having size 4 (M=4).

Referring to FIG. 7, 7-1 represents a sub-band having length of 12 physical resource block, and 7-2 represents another sub-band having length of 12 physical resource blocks. 7-3 represents a comb offset pattern having size (or length) of M=4. In the sub-band 7-1, a physical resource block, PRB #x, maps to comb offset pattern k=0, and in the sub-band 7-2, a physical resource block PRB #x+1, maps to comb offset pattern k=1. 7-4 in FIG. 7 represents 12 physical resource blocks with 3 cyclically shifted M=4 comb offset patterns. The pattern elements correspond to different comb offsets.

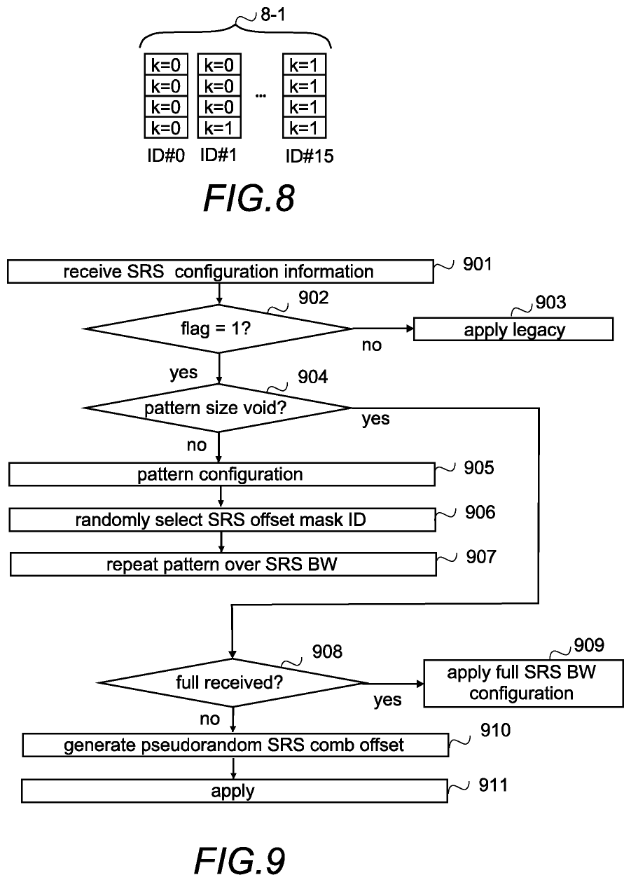

FIG. 8 illustrates a simplified examples of candidate patterns 8-1 with pattern identifiers, IDs, for comb-2 with M=4. For example, when the apparatus UE is pre-configured with two pattern sizes, with limited number of patterns for different time instances T, as illustrated in the below table with 3 time instances, one bit downlink control information message may convey the information with means of which the apparatus UE knows the pattern size and is able to select one of the pattern identifiers and to apply the selected pattern amongst the candidate patterns.

| M | T = 1 | T = 2 | T = 3 |
|---|---|---|---|
| 4 | ID#{0, 3, 6, 9, 10} | ID#{0, 3, 6, 9, 10} | ID#{4, 5, 6, 12, 15} |
| 8 | ID#{2, 8, 11, 36, 56} | ID#{2, 8, 11, 36, 56} | ID#{13, 22, 51, 59} |

Furthermore, for example via MAC CE signaling, a subset of the candidates may be defined. For example, MAC CE signaling may indicate bolded pattern identifiers in the table below, and then the apparatus UE performs the random selection amongst bolded pattern identifiers.

| M | T = 1 | T = 2 | T = 3 |
|---|---|---|---|
| 4 | ID#{0, 3, 6, 9, 10} | ID#{0, 3, 6, 9, 10} | ID#{4, 5, 6, 12, 15} |
| 8 | ID#{2, 8, 11, 36, 56} | ID#{2, 8, 11, 36, 56} | ID#{13, 22, 51, 59} |

In an implementation, the apparatus UE may be configured to support all disclosed comb offset randomization schemes. FIG. 9 illustrates a non-limiting example of a functionality of the apparatus UE.

Referring to FIG. 9, sounding reference signal configuration information is received in block 901, for example as described above with FIGS. 4 to 8.

When the indication, which in the illustrated example is a flag, is received, it is checked in block 902, whether to apply a comb offset randomization scheme. In the illustrated example, if the value of the flag is not 1 (block 902: no), a legacy comb offset is applied in block 903.

If the value of the flag is 1 (block 902: yes), in the illustrated example it means that a comb offset randomization scheme is to be applied. Then it is checked, whether a bit (or bits) indicating a pattern size is void. For example, upon reception of downlink control information DCI, it may be checked in block 904, whether a DCI codepoint field, for example a “CombOffsetPattern-Indicator” field, associated with comb offset indication is “void/empty”. If not, the pattern configuration to use is determined using earlier received pattern configurations, for example such as illustrated in the above tables, and the one or more bits in the DCI is then used to select in block 905 the pattern configuration amongst the possible different pattern configurations. Then an SRS offset pattern identifier ID is selected in block 906 amongst the identifiers in the pattern configuration, as is explained above, and the selected pattern is repeated in block 907 over the sounding reference signal SRS bandwidth BW with possible cyclic shifts.

If the bit (or bits) indicating a pattern size is void (block 904: yes), it is checked in block 908, whether a full comb offset randomization scheme has been received in the sounding reference signal configuration information. The full comb offset randomization scheme refers to the scheme illustrated with FIG. 4 in which the comb offset patterns are at physical resource block level, and the configuration may be called a full sounding reference signal SRS bandwidth BW configuration.

If the full comb offset randomization scheme has been received (block 908: yes), it is applied in block 909 for sounding reference transmissions.

If the full comb offset randomization scheme has not been received (block 908: no), a pseudorandom sounding reference signal comb offset value is generated in block 910 using at least the index of the apparatus UE, an index associated with the sub-band, and a time instance. Further, when DCI contains at least one specific comb offset value, it is also used when generating the pseudorandom sounding reference signal comb offset value. Then the generated sounding reference signal comb offset value is applied in block 911 to a sounding reference signal transmission.

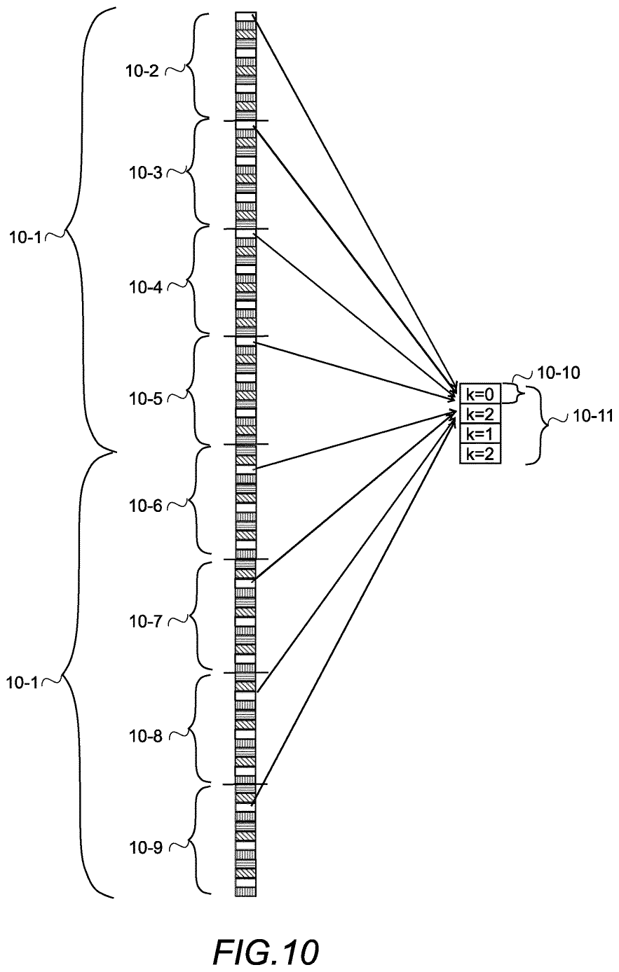

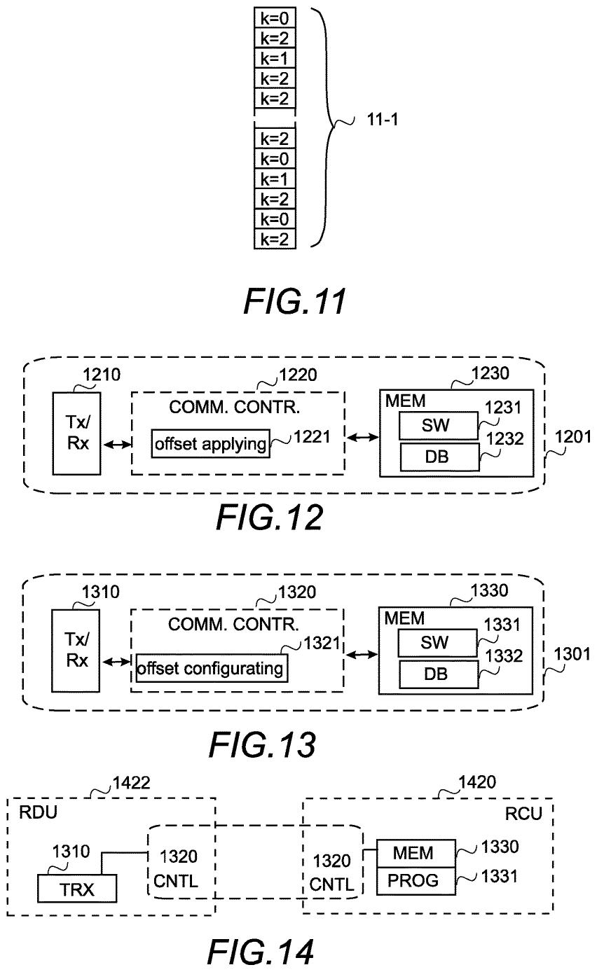

As discussed above, to a hopping pattern for the comb offset scheme, the comb offset may be configured in both the frequency domain and the time domain. FIGS. 10 and 11 illustrate different examples of comb offsets.

FIG. 10 illustrates an example of comb offset pattern in the frequency domain with length of 16 PRBs where each value of the comb offset pattern corresponds to a fixed comb offset value over 4 PRBs resource. The number of PRBs associated with fixed comb offset value depends on comb type and maximum number of cyclic shifts. The number of PRBs can be used as a processing window over which orthogonality between cyclic-shifts and sequences can be maintained at the network side. It is worth also noting that antenna ports within one SRS resource can be configured with a resource specific comb offset value on top of which pseudorandom comb offset pattern may be applied. The sounding reference signal transmitting apparatus, e.g. the apparatus UE may be configured with a single comb offset pattern which will be applied over entire UL SRS bandwidth. In FIG. 10, 10-1 denotes RX (reception) processing window in the frequency domain, 10-2 denotes PRB #x, comb offset k=0, 10-3 denotes PRB #x+1, comb offset k=0, 10-4 denotes PRB #x+2, comb offset k=0, 10-5 denotes PRB #x+3, comb offset k=0, 10-6 denotes PRB #x+4, comb offset k=2, 10-7 denotes PRB #x+5, comb offset k=2, 10-8 denotes PRB #x+6, comb offset k=2, and 10-9 denotes PRB #x+7, comb offset k=2. One block 10-10 denotes in FIG. 10 the 4 PRB resources, and 10-11 denotes the comb offset pattern of length M=16 PRBs.

FIG. 11 illustrates another example, in which, to randomize interference even further, the sounding reference signal transmitting apparatus, e.g. the apparatus UE, may be configured to apply the comb offset pattern cyclically over the entire UL SRS bandwidth. In the example of FIG. 11, the comb offset pattern is a three cyclically shifted comb offset pattern with length of 4 in the frequency domain, 11-1 denoting 48 PRBs with 3 cyclically shifted M=16 length comb offset pattern.

The blocks, related functions, and information exchanges (messages/signals) described above by means of FIG. 2 to FIG. 5 and FIG. 9 are in no absolute chronological order, and some of them may be performed simultaneously or in an order differing from the given one. Other functions can also be executed between them or within them, and other information may be transmitted, and/or other rules applied. Some of the blocks or part of the blocks or one or more pieces of information can also be left out or replaced by a corresponding block or part of the block or one or more pieces of information. Furthermore, some of the blocks in one example may be combined with another example.

FIG. 12 illustrates an apparatus 1201 according to some embodiments. The apparatus 1201 may be an apparatus, e.g. the apparatus UE, configured to receive one or more comb randomization schemes and transmit sounding reference signals. FIG. 13 illustrates an apparatus 1301 according to some embodiments. The apparatus 1301 may be an apparatus, the apparatus gNB, that may be configured to transmit comb randomization schemes and receive sounding reference signals. FIG. 14 illustrates an apparatus that may implement distributed functionality of the apparatus illustrated in FIG. 13. Different examples of such apparatuses are described above.

The apparatus 1201, 1301 may comprise one or more communication control circuitries 1220, 1320, such as at least one processor, and at least one memory 1230, including one or more algorithms 1231, 1331, such as a computer program code (software, SW, or instructions) wherein the at least one memory and the computer program code (software) are configured, with the at least one processor, to cause the apparatus to carry out any one of the exemplified functionalities of a corresponding apparatus, described above with any of FIG. 1 to FIG. 11. Said at least one memory 1230, 1330 may also comprise at least one database (DB) 1232, 1332.

Referring to FIG. 12, the one or more communication control circuitries 1220 of the apparatus 1201 comprise at least an offset applying circuitry 1221 which is configured to perform sounding reference transmission related functionalities, e.g. apply at least one comb offset randomization scheme, according to embodiments. To this end, the offset applying circuitry 1221 of the apparatus 1201 is configured to carry out at least some of the functionalities described above, e.g., by means of FIG. 2 to FIG. 11, using one or more individual circuitries.

Referring to FIG. 12, the memory 1230 may be implemented using any suitable data storage technology, such as semiconductor based memory devices, flash memory, magnetic memory devices and systems, optical memory devices and systems, fixed memory and removable memory.

Referring to FIG. 12, the apparatus 1201 may further comprise different interfaces 1210 such as one or more communication interfaces (TX/RX) comprising hardware and/or software for realizing communication connectivity according to one or more communication protocols. The one or more communication interfaces 1210 may enable connecting to the Internet and/or to a core network of a wireless communications network and/or to a radio access network and/or to other apparatuses within range of the apparatus. The one or more communication interface 1210 may provide the apparatus with communication capabilities to communicate in a cellular communication system and enable communication to different network nodes or elements. The one or more communication interfaces 1210 may comprise standard well-known components such as an amplifier, filter, frequency-converter, (de) modulator, and encoder/decoder circuitries, controlled by the corresponding controlling units, and possibly one or more antennas.

Referring to FIG. 13, the one or more communication control circuitry 1320 of the apparatus 1301 comprise at least an offset configurating circuitry 1321, which is configured to include or not to include into its transmissions one or more comb offset randomization schemes and one or more indications whether to apply such scheme(s), that are discussed with FIG. 2 to FIG. 11. To this end, the offset configurating circuitry 1321 of the apparatus 1301 is configured to carry out at least some of the functionalities of the apparatus gNB, or access device, described above, e.g., by means of FIG. 1 to FIG. 11, for example, using one or more individual circuitries.

Referring to FIG. 13, the memory 1330 may be implemented using any suitable data storage technology, such as semiconductor based memory devices, flash memory, magnetic memory devices and systems, optical memory devices and systems, fixed memory and removable memory.

Referring to FIG. 13, the apparatus 1301 may further comprise different interfaces 1310 such as one or more communication interfaces (TX/RX) comprising hardware and/or software for realizing communication connectivity according to one or more communication protocols. The one or more communication interfaces 1310 may enable connecting to the Internet and/or to a core network of a wireless communications network. The one or more communication interface 1310 may provide the apparatus with communication capabilities to communicate in a cellular communication system and enable communication to different network nodes or elements or devices in the downlink, such as the apparatus UE, for example. The one or more communication interfaces 1310 may comprise standard well-known components such as an amplifier, filter, frequency-converter, (de) modulator, and encoder/decoder circuitries, controlled by the corresponding controlling units, and one or more antennas.

In an embodiment, as shown in FIG. 14, at least some of the functionalities of the apparatus of FIG. 13 may be shared between two physically separate devices, forming one operational entity. Therefore, the apparatus may be seen to depict the operational entity comprising one or more physically separate devices for executing at least some of the described processes. Thus, the apparatus of FIG. 14, utilizing such shared architecture, may comprise a remote control unit RCU 1420, such as a host computer or a server computer, operatively coupled (e.g. via a wireless or wired network) to a remote distributed unit RDU 1422 located in a base station, for example. In an embodiment, at least some of the described processes may be performed by the RCU 1420. In an embodiment, the execution of at least some of the described processes may be shared among the RDU 1422 and the RCU 1420.

Similar to FIG. 13, the apparatus of FIG. 14 may comprise one or more communication control circuitry (CNTL) 1320, such as at least one processor, and at least one memory (MEM) 1330, including one or more algorithms (PROG) 1331, such as a computer program code (software SW, or instructions) wherein the at least one memory and the computer program code (software, instructions) are configured, with the at least one processor, to cause the apparatus to carry out any one of the exemplified functionalities of the apparatus in a network side described above, e.g., by means of FIG. 1, to FIG. 11, for example, by the apparatus gNB, or access device.

In an embodiment, the RCU 1420 may generate a virtual network through which the RCU 1420 communicates with the RDU 1422. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (e.g. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RDU and the RCU. In practice, any digital signal processing task may be performed in either the RDU or the RCU and the boundary where the responsibility is shifted between the RDU and the RCU may be selected according to implementation.

In a still further embodiment, the apparatus of FIG. 12 may be implemented in similar way as the apparatus of FIG. 14.

As used in this application, the term ‘circuitry’ may refer to one or more or all of the following: (a) hardware-only circuit implementations, such as implementations in only analog and/or digital circuitry, and (b) combinations of hardware circuits and software (and/or firmware), such as (as applicable): (i) a combination of analog and/or digital hardware circuit(s) with software/firmware and (ii) any portions of hardware processor(s) with software, including digital signal processor(s), software, and memory(ies) that work together to cause an apparatus, such as a terminal device or an access node, to perform various functions, and (c) hardware circuit(s) and processor(s), such as a microprocessor(s) or a portion of a microprocessor(s), that requires software (e.g. firmware) for operation, but the software may not be present when it is not needed for operation. This definition of ‘circuitry’ applies to all uses of this term in this application, including any claims. As a further example, as used in this application, the term ‘circuitry’ also covers an implementation of merely a hardware circuit or processor (or multiple processors) or a portion of a hardware circuit or processor and its (or their) accompanying software and/or firmware. The term ‘circuitry’ also covers, for example and if applicable to the particular claim element, a baseband integrated circuit for an access node or a terminal device or other computing or network device.

In an embodiment, at least some of the processes described in connection with FIG. 1 to FIG. 11 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIG. 1 to FIG. 11 or operations thereof.

Embodiments and examples as described may also be carried out in the form of a computer process defined by a computer program or portions thereof. Embodiments of the functionalities described in connection with FIG. 1 to FIG. 11 may be carried out by executing at least one portion of a computer program comprising corresponding instructions. The computer program may be provided as a computer readable medium comprising program instructions stored thereon or as a non-transitory computer readable medium comprising program instructions stored thereon. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. The term “non-transitory,” as used herein, is a limitation of the medium itself (i.e., tangible, not a signal) as opposed to a limitation on data storage persistency (e.g., random access memory RAM vs. read only memory ROM). Coding of software for carrying out the embodiments as shown and described is well within the scope of a person of ordinary skill in the art.

Even though the embodiments have been described above with reference to examples according to the accompanying drawings, it is clear that the embodiments are not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising at least one processor and at least one memory storing instructions that, when executed by the at least one processor, cause the apparatus at least to:
receive sounding reference signal configuration information on at least one comb offset randomization scheme, which indicates at least division of a sounding reference signal bandwidth to a plurality of sub-bands and associated comb offset values;
receive an indication, whether to apply a comb offset randomization scheme; and
apply one of the at least one comb offset randomization scheme for sounding reference signal transmissions when the indication indicates to apply the comb offset randomization scheme.

2. The apparatus of claim 1, wherein the at least one processor and the at least one memory storing instructions, when executed by the at least one processor, further cause the apparatus at least to:
receive at least a first comb offset randomization scheme comprising comb offset candidate patterns for multiple pattern sizes, a candidate pattern having a pattern identifier and being associated with a pattern size;
receive an indication of a pattern size to be used with the sounding reference signal transmissions; and
select, based on the pattern size indicated, from the candidate comb offset patterns, a comb offset pattern to be applied for the sounding reference signal transmissions.

3. The apparatus of claim 2, wherein the at least one processor and the at least one memory storing instructions, when executed by the at least one processor, further cause the apparatus at least to:
receive a selection of a subset of the comb offset candidate patterns; and
select the comb offset pattern from the subset of the comb offset candidate patterns.

4. The apparatus of claim 2, wherein the at least one processor and the at least one memory storing instructions, when executed by the at least one processor, further cause the apparatus at least to:
receive a second comb offset randomization scheme comprising a plurality of comb offset patterns, a comb offset pattern per a set of resource blocks associated with the sounding reference signal bandwidth; and
apply, when no indication of the pattern size is received, the second comb offset randomization scheme for the sounding reference signal transmissions.

5. The apparatus of claim 4, wherein the at least one processor and the at least one memory storing instructions, when executed by the at least one processor, further cause the apparatus at least to:
receive a third comb offset randomization scheme indicating the division of the sounding reference signal bandwidth and use of the pseudorandom comb offset values; and
generate, when no indication of the pattern size and no second comb offset randomization scheme are received, pseudorandom comb offset values using at least an index of the apparatus, an index associated with a sub-band and a time instance; and
apply pseudorandom comb offset values generated for the sounding reference signal transmissions.

6. The apparatus of claim 2, wherein the at least one processor and the at least one memory storing instructions, when executed by the at least one processor, further cause the apparatus at least to:
receive a third comb offset randomization scheme indicating the division of the sounding reference signal bandwidth and use of the pseudorandom comb offset values; and
generate, when no indication of the pattern size and no second comb offset randomization scheme are received, pseudorandom comb offset values using at least an index of the apparatus, an index associated with a sub-band and a time instance; and
apply pseudorandom comb offset values generated for the sounding reference signal transmissions.

7. The apparatus of claim 1, wherein the at least one processor and the at least one memory storing instructions, when executed by the at least one processor, further cause the apparatus at least to:
generate pseudorandom comb offset values using at least an index of the apparatus, an index associated with a sub-band and a time instance;
apply pseudorandom comb offset values generated for the sounding reference signal transmissions.

8. The apparatus of claim 5, wherein the at least one processor and the at least one memory storing instructions, when executed by the at least one processor, further cause the apparatus at least to:
receive at least one specific comb offset value; and
generate pseudorandom comb offset values using also the at least one specific comb offset value to generate pseudorandom comb offset values.

9. The apparatus of claim 1, wherein the at least one comb offset randomization scheme comprises a plurality of comb offset patterns, a comb offset pattern per a set of resource blocks associated with the sounding reference signal bandwidth.

10. An apparatus comprising at least one processor and at least one memory storing instructions that, when executed by the at least one processor, cause the apparatus at least to:
transmit sounding reference signal configuration information on at least one comb offset randomization scheme, which indicates at least division of a sounding reference signal bandwidth to a plurality of sub-bands and associated comb offset values;
transmit to at least one second apparatus an indication to apply a comb offset randomization scheme; and
process, using the comb offset randomization scheme, sounding reference signal transmission received from the at least one second apparatus.

11. The apparatus of claim 10, wherein the at least one processor and the at least one memory storing instructions, when executed by the at least one processor, further cause the apparatus at least to:
transmit to the at least one second apparatus a first comb offset randomization scheme comprising comb offset candidate patterns for multiple pattern sizes, a candidate pattern having a pattern identifier and being associated with a pattern size; and
transmit to the at least one second apparatus an indication of a pattern size.

12. The apparatus of claim 11, wherein the at least one processor and the at least one memory storing instructions, when executed by the at least one processor, further cause the apparatus at least to:
select one or more subsets from the comb offset candidate patterns for multiple pattern sizes; and
transmit at least to one of the at least one second apparatus in the first comb offset randomization scheme a subset of the comb offset candidate patterns.

13. The apparatus of claim 10, wherein the at least one processor and the at least one memory storing instructions, when executed by the at least one processor, further cause the apparatus at least to transmit a second comb offset randomization scheme comprising a plurality of comb offset patterns, a comb offset pattern per a set of resource blocks associated with the sounding reference signal bandwidth.

14. The apparatus of claim 10, wherein the at least one processor and the at least one memory storing instructions, when executed by the at least one processor, further cause the apparatus at least to:
transmit a third comb offset randomization scheme indicating the division of the sounding reference signal bandwidth and use of the pseudorandom comb offset values; and
generate, per a received sounding reference signal from a second apparatus, a pseudorandom comb offset value using at least an index of the second apparatus, an index associated with the sub-band and a time instance of the sounding reference signal.

15. The apparatus of claim 14, wherein the at least one processor and the at least one memory storing instructions, when executed by the at least one processor, further cause the apparatus at least to:
transmit to a second apparatus in the third comb offset randomization scheme a at least one specific comb offset value that is assigned to the second apparatus; and
use the at least one specific comb offset value when processing sounding reference signals from the second apparatus.

16. A method comprising:
receiving sounding reference signal configuration information on at least one comb offset randomization scheme, which indicates at least division of a sounding reference signal bandwidth to a plurality of sub-bands and associated comb offset values;
receiving an indication, whether to apply a comb offset randomization scheme; and
applying one of the at least one comb offset randomization scheme for sounding reference signal transmissions when the indication indicates to apply the comb offset randomization scheme.

17. The method of claim 16, further comprising:
receiving a first comb offset randomization scheme comprising comb offset candidate patterns for multiple pattern sizes, a candidate pattern having a pattern identifier and being associated with a pattern size;
receiving an indication of a pattern size to be used with the sounding reference signal transmissions; and
selecting, based on the pattern size indicated, from the candidate comb offset patterns, a comb offset pattern to be applied for the sounding reference signal transmissions.

18. The method of claim 17, further comprising:
receiving a selection of a subset of the comb offset candidate patterns; and
selecting the comb offset pattern from the subset of the comb offset candidate patterns.

19. The method of claim 17, further comprising:
receiving a second comb offset randomization scheme comprising a plurality of comb offset patterns, a comb offset pattern per a set of resource blocks associated with the sounding reference signal bandwidth; and
applying, when no indication of the pattern size is received, the second comb offset randomization scheme for the sounding reference signal transmissions.

20. The method of claim 19, further comprising:
receiving a third comb offset randomization scheme indicating the division of the sounding reference signal bandwidth and use of the pseudorandom comb offset values;
generating, when no indication of the pattern size and no second comb offset randomization scheme are received, pseudorandom comb offset values using at least an index of the apparatus, an index associated with a sub-band and a time instance; and
applying the pseudorandom comb offset values generated for the sounding reference signal transmissions.

21.-51. (canceled)
